(19) United States
(12) Patent Application Publication
(10) Pub. No.: US 2006/0069207 A1
(43) Pub. Date: Mar. 30, 2006

(54) Resinous composition with improved resistance to plate-out formation, and method

(75) Inventors: Sandeep Dhawan, Vienna, WV (US); Satish Kumar Gaggar, Parkersburg, WV (US); Wenyu Shang, Shanghai (CN); Shuwen Peng, Shanghai (CN); Patricia Bin Sun, Parkersburg, WV (US); Christiaan Henricus Johannes Koevoets, Heesterberg 40,4708 HS Roosendaal (NL)

Correspondence Address: Henry H. Gibson;GE Plastics, One Plastics Avenue, Pittsfield, MA, 01201, US

(73) Assignee: General Electric Company

(21) Appl. No.: 10/953,722

(22) Filed: Sep. 29, 2004

(51) Int. Cl. C08F 8/00

(52) U.S. Cl. 525/191

(57) ABSTRACT

Disclosed are compositions comprising: (i) a rubber modified thermoplastic resin comprising a discontinuous elastomeric phase dispersed in a rigid thermoplastic phase, wherein at least a portion of the rigid thermoplastic phase is grafted to the elastomeric phase; (ii) at least two additives selected from the group consisting of glass beads; fluoropolymers; ethylene bis-stearamide; a mixture of at least one metal salt of a fatty acid and at least one amide; a homopolymer comprising structural units derived from at least one (C₁-C₁₂)alkyl(meth)acrylate monomer; and mixtures thereof; and optionally (iii) at least one additive selected from the group consisting of a silicone oil and a linear low density polyethylene; wherein said composition has a critical shear rate value of greater than about 50 reciprocal seconds as measured at 190° C. in a capillary rheometer with 10 mm length and 1 mm diameter. In other embodiments the present invention comprises a method to reduce or eliminate plate-out formation in compositions comprising rubber modified thermoplastic resins. In still other embodiments the present invention comprises articles made from said compositions.

### BACKGROUND OF THE INVENTION

The present invention relates to resinous compositions which exhibit improved resistance to plate-out formation during processing. In particular embodiments the present invention relates to compositions comprising a rubber modified thermoplastic resin comprising a discontinuous elastomeric phase dispersed in a rigid thermoplastic phase, wherein at least a portion of the rigid thermoplastic phase is grafted to the elastomeric phase; and additives which may serve to reduce or eliminate plate-out during thermal processing of the composition.

Acrylonitrile-styrene-acrylate (ASA) graft copolymers typically exhibit serious plate-out and gloss line surface issues when used in applications requiring extrusion processing. Illustrative examples of such extrusion processes comprise extrusion of profile, sheet, pipe or other similar processes typically including a vacuum calibrator to keep the dimension of the extrudate accurate. The applied vacuum of the calibrator may significantly affect the plate-out and gloss lines of the extrudate. In some cases it has been observed that the higher the vacuum level of the calibrator, the more serious plate-out and gloss line phenomena are.

It is believed that the plate-out and gloss line issues are caused by melt fracture phenomena and the friction and scratch between, for example, the surface of the calibrator and the polymer melt. When the shear rate of the extrusion process exceeds the critical shear rate of the polymer, the polymer melt may generate unstable flow. With the presence of this unstable flow, surface irregularities may occur and surface roughness may be increased. When such a rough surfaced melt goes into a vacuum calibrator, where the negative pressure will suck the molten polymer against the cool metal surface, the friction and scratch effect between calibrator and polymer melt can pull material, such as small rubber particles, out of the polymer melt, and cause plate-out phenomena. At the same time, the friction will change the gloss level at multiple points across the width of the extrudate because the contact between calibrator surface and polymer melt is not even across the same width. This gloss level variation is observed as gloss lines on the finished parts. Therefore, a need exists for a thermoplastic composition which can attain good appearance without plate-out and gloss lines after an extrusion process, while retaining an adequate balance of other properties.

### BRIEF DESCRIPTION OF THE INVENTION

The present inventors have discovered novel compositions which exhibit improved resistance to plate-out formation during processing, while maintaining other desirable physical properties, including weatherability. In one embodiment the present invention comprises a composition comprising: (i) a rubber modified thermoplastic resin comprising a discontinuous elastomeric phase dispersed in a rigid thermoplastic phase, wherein at least a portion of the rigid thermoplastic phase is grafted to the elastomeric phase; (ii) at least two additives selected from the group consisting of glass beads; fluoropolymers; ethylene bis-stearamide; a mixture of at least one metal salt of a fatty acid and at least one amide; a homopolymer comprising structural units derived from at least one (C₁-C₁₂)alkyl(meth)acrylate monomer; and mixtures thereof; and optionally (iii) at least one additive selected from the group consisting of a silicone oil and a linear low density polyethylene; wherein said composition has a critical shear rate value of greater than about 50 reciprocal seconds as measured at 190° C. in a capillary rheometer with 10 mm length and 1 mm diameter. In other embodiments the present invention comprises a method to reduce or eliminate plate-out formation in compositions comprising rubber modified thermoplastic resins. In still other embodiments the present invention comprises articles made from said compositions. Various other features, aspects, and advantages of the present invention will become more apparent with reference to the following description and appended claims.

### DETAILED DESCRIPTION OF THE INVENTION

In the following specification and the claims which follow, reference will be made to a number of terms which shall be defined to have the following meanings. The singular forms “a”, “an” and “the” include plural referents unless the context clearly dictates otherwise. “Optional” or “optionally” means that the subsequently described event or circumstance may or may not occur, and that the description includes instances where the event occurs and instances where it does not. The terminology “monoethylenically unsaturated” means having a single site of ethylenic unsaturation per molecule. The terminology “polyethylenically unsaturated” means having two or more sites of ethylenic unsaturation per molecule. The terminology “(meth)acrylate” refers collectively to acrylate and methacrylate; for example, the term “(meth)acrylate monomers” refers collectively to acrylate monomers and methacrylate monomers. The term “(meth)acrylamide” refers collectively to acrylamides and methacrylamides.

The term “alkyl” as used in the various embodiments of the present invention is intended to designate linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. Alkyl groups may be saturated or unsaturated, and may comprise, for example, vinyl or allyl. The term “alkyl” also encompasses that alkyl portion of alkoxide groups. In various embodiments normal and branched alkyl radicals are those containing from 1 to about 32 carbon atoms, and include as illustrative non-limiting examples C₁-C₃₂ alkyl (optionally substituted with one or more groups selected from C₁-C₃₂ alkyl, C₃-C₁₅ cycloalkyl or aryl); and C₃-C₁₅ cycloalkyl optionally substituted with one or more groups selected from C₁-C₃₂ alkyl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl. The term “aryl” as used in the various embodiments of the present invention is intended to designate substituted or unsubstituted aryl radicals containing from 6 to 20 ring carbon atoms. Some illustrative non-limiting examples of these aryl radicals include C₆-C₂₀ aryl optionally substituted with one or more groups selected from C₁-C₃₂ alkyl, C₃-C₁₅ cycloalkyl, aryl, and functional groups comprising atoms selected from Groups 15, 16 and 17 of the Periodic Table. Some particular illustrative examples of aryl radicals comprise substituted or unsubstituted phenyl, biphenyl, tolyl, naphthyl and binaphthyl.

Compositions of the present invention comprise a rubber modified thermoplastic resin comprising a discontinuous elastomeric phase dispersed in a rigid thermoplastic phase, wherein at least a portion of the rigid thermoplastic phase is grafted to the elastomeric phase. The rubber modified thermoplastic resin employs at least one rubber substrate for grafting. The rubber substrate comprises the discontinuous elastomeric phase of the composition. There is no particular limitation on the rubber substrate provided it is susceptible to grafting by at least a portion of a graftable monomer. In some embodiments suitable rubber substrates comprise dimethyl siloxane/butyl acrylate rubber, or silicone/butyl acrylate composite rubber; polyolefin rubbers such as ethylene-propylene rubber or ethylene-propylene-diene (EPDM) rubber; or silicone rubber polymers such as polymethyl siloxane rubber. The rubber substrate typically has a glass transition temperature, Tg, in one embodiment less than or equal to 25° C., in another embodiment below about 0° C., in another embodiment below about minus 20° C., and in still another embodiment below about minus 30° C. As referred to herein, the Tg of a polymer is the T value of polymer as measured by differential scanning calorimetry (DSC; heating rate 20° C./minute, with the Tg value being determined at the inflection point).

In one embodiment the rubber substrate is derived from polymerization by known methods of at least one monoethylenically unsaturated alkyl (meth)acrylate monomer selected from (C₁-C₁₂)alkyl(meth)acrylate monomers and mixtures comprising at least one of said monomers. As used herein, the terminology “(Cₓ-C_{y})”, as applied to a particular unit, such as, for example, a chemical compound or a chemical substituent group, means having a carbon atom content of from “x” carbon atoms to “y” carbon atoms per such unit. For example, “(C₁-C₁₂)alkyl” means a straight chain, branched or cyclic alkyl substituent group having from 1 to 12 carbon atoms per group. Suitable (C₁-C₁₂)alkyl(meth)acrylate monomers include, but are not limited to, (C₁-C₁₂)alkyl acrylate monomers, illustrative examples of which comprise ethyl acrylate, butyl acrylate, iso-pentyl acrylate, n-hexyl acrylate, and 2-ethyl hexyl acrylate; and their (C₁-C₁₂)alkyl methacrylate analogs, illustrative examples of which comprise methyl methacrylate, ethyl methacrylate, propyl methacrylate, iso-propyl methacrylate, butyl methacrylate, hexyl methacrylate, and decyl methacrylate. In a particular embodiment of the present invention the rubber substrate comprises structural units derived from n-butyl acrylate.

In various embodiments the rubber substrate may also optionally comprise a minor amount, for example up to about 5 wt. %, of structural units derived from at least one polyethylenically unsaturated monomer, for example those that are copolymerizable with a monomer used to prepare the rubber substrate. A polyethylenically unsaturated monomer is often employed to provide cross-linking of the rubber particles and/or to provide “graftlinking” sites in the rubber substrate for subsequent reaction with grafting monomers. Suitable polyethylenically unsaturated monomers include, but are not limited to, butylene diacrylate, divinyl benzene, butene diol dimethacrylate, trimethylolpropane tri(meth)acrylate, allyl methacrylate, diallyl methacrylate, diallyl maleate, diallyl fumarate, diallyl phthalate, triallyl methacrylate, triallyl cyanurate, triallyl isocyanurate, the acrylate of tricyclodecenylalcohol and mixtures comprising at least one of such monomers. In a particular embodiment the rubber substrate comprises structural units derived from triallyl cyanurate.

In some embodiments the rubber substrate may optionally comprise structural units derived from minor amounts of other unsaturated monomers, for example those that are copolymerizable with a monomer used to prepare the rubber substrate. In particular embodiments the rubber substrate may optionally include up to about 25 wt. % of structural units derived from one or more monomers selected from (meth)acrylate monomers, alkenyl aromatic monomers and monoethylenically unsaturated nitrile monomers. Suitable copolymerizable (meth)acrylate monomers include, but are not limited to, C₁-C₁₂ aryl or haloaryl substituted acrylate, C₁-C₁₂ aryl or haloaryl substituted methacrylate, or mixtures thereof; monoethylenically unsaturated carboxylic acids, such as, for example, acrylic acid, methacrylic acid and itaconic acid; glycidyl (meth)acrylate, hydroxy alkyl (meth)acrylate, hydroxy(C₁-C₁₂)alkyl (meth)acrylate, such as, for example, hydroxyethyl methacrylate; (C₄-C₁₂)cycloalkyl (meth)acrylate monomers, such as, for example, cyclohexyl methacrylate; (meth)acrylamide monomers, such as, for example, acrylamide, methacrylamide and N-substituted-acrylamide or N-substituted-methacrylamides; maleimide monomers, such as, for example, maleimide, N-alkyl maleimides, N-aryl maleimides, N-phenyl maleimide, and haloaryl substituted maleimides; maleic anhydride; methyl vinyl ether, ethyl vinyl ether, and vinyl esters, such as, for example, vinyl acetate and vinyl propionate. Suitable alkenyl aromatic monomers include, but are not limited to, vinyl aromatic monomers, such as, for example, styrene and substituted styrenes having one or more alkyl, alkoxy, hydroxy or halo substituent groups attached to the aromatic ring, including, but not limited to, alpha-methyl styrene, p-methyl styrene, 3,5-diethylstyrene, 4-n-propylstyrene, 4-isopropylstyrene, vinyl toluene, alpha-methyl vinyl toluene, vinyl xylene, trimethyl styrene, butyl styrene, t-butyl styrene, chlorostyrene, alpha-chlorostyrene, dichlorostyrene, tetrachlorostyrene, bromostyrene, alpha-bromostyrene, dibromostyrene, p-hydroxystyrene, p-acetoxystyrene, methoxystyrene and vinyl-substituted condensed aromatic ring structures, such as, for example, vinyl naphthalene, vinyl anthracene, as well as mixtures of vinyl aromatic monomers and monoethylenically unsaturated nitrile monomers such as, for example, acrylonitrile, ethacrylonitrile, methacrylonitrile, alpha-bromoacrylonitrile and alpha-chloro acrylonitrile. Substituted styrenes with mixtures of substituents on the aromatic ring are also suitable. As used herein, the term “monoethylenically unsaturated nitrile monomer” means an acyclic compound that includes a single nitrile group and a single site of ethylenic unsaturation per molecule and includes, but is not limited to, acrylonitrile, methacrylonitrile, alpha-chloro acrylonitrile, and the like.

In a particular embodiment the rubber substrate comprises repeating units derived from one or more (C₁-C₁₂)alkyl acrylate monomers. In still another particular embodiment, the rubber substrate comprises from 40 to 95 wt. % repeating units derived from one or more (C₁-C₁₂)alkyl acrylate monomers, and more preferably from one or more monomers selected from ethyl acrylate, butyl acrylate and n-hexyl acrylate.

The rubber substrate may be present in the rubber modified thermoplastic resin in one embodiment at a level of from about 4 wt. % to about 94 wt. %; in another embodiment at a level of from about 10 wt. % to about 80 wt. %; in another embodiment at a level of from about 15 wt. % to about 80 wt. %; in another embodiment at a level of from about 35 wt. % to about 80 wt. %; in another embodiment at a level of from about 40 wt. % to about 80 wt. %; in another embodiment at a level of from about 25 wt. % to about 60 wt. %, and in still another embodiment at a level of from about 40 wt. % to about 50 wt. %, based on the weight of the rubber modified thermoplastic resin. In other embodiments the rubber substrate may be present in the rubber modified thermoplastic resin at a level of from about 5 wt. % to about 50 wt. %; at a level of from about 8 wt. % to about 40 wt. %; or at a level of from about 10 wt. % to about 30 wt. %, based on the weight of the particular rubber modified thermoplastic resin.

There is no particular limitation on the particle size distribution of the rubber substrate (sometimes referred to hereinafter as initial rubber substrate to distinguish it from the rubber substrate following grafting). In some embodiments the initial rubber substrate may possess a broad, essentially monomodal, particle size distribution with particles ranging in size from about 50 nanometers (nm) to about 1000 nm. In other embodiments the mean particle size of the initial rubber substrate may be less than about 100 nm. In still other embodiments the mean particle size of the initial rubber substrate may be in a range of between about 80 nm and about 400 nm. In other embodiments the mean particle size of the initial rubber substrate may be greater than about 400 nm. In still other embodiments the mean particle size of the initial rubber substrate may be in a range of between about 400 nm and about 750 nm. In still other embodiments the initial rubber substrate comprises particles which are a mixture of particle sizes with at least two mean particle size distributions. In a particular embodiment the initial rubber substrate comprises a mixture of particle sizes with each mean particle size distribution in a range of between about 80 nm and about 750 nm. In another particular embodiment the initial rubber substrate comprises a mixture of particle sizes, one with a mean particle size distribution in a range of between about 80 nm and about 400 nm; and one with a broad and essentially monomodal mean particle size distribution.

The rubber substrate may be made according to known methods, such as, but not limited to, a bulk, solution, or emulsion process. In one non-limiting embodiment the rubber substrate is made by aqueous emulsion polymerization in the presence of a free radical initiator, e.g., an azonitrile initiator, an organic peroxide initiator, a persulfate initiator or a redox initiator system, and, optionally, in the presence of a chain transfer agent, e.g., an alkyl mercaptan, to form particles of rubber substrate.

The rigid thermoplastic resin phase of the rubber modified thermoplastic resin comprises one or more thermoplastic polymers. In one embodiment of the present invention monomers are polymerized in the presence of the rubber substrate to thereby form a rigid thermoplastic phase, at least a portion of which is chemically grafted to the elastomeric phase. The portion of the rigid thermoplastic phase chemically grafted to rubber substrate is sometimes referred to hereinafter as grafted copolymer. The rigid thermoplastic phase comprises a thermoplastic polymer or copolymer that exhibits a glass transition temperature (Tg) in one embodiment of greater than about 25° C., in another embodiment of greater than or equal to 90° C., and in still another embodiment of greater than or equal to 100° C.

In a particular embodiment the rigid thermoplastic phase comprises a polymer having structural units derived from one or more monomers selected from the group consisting of (C₁-C₁₂)alkyl-(meth)acrylate monomers, aryl-(meth)acrylate monomers, alkenyl aromatic monomers and monoethylenically unsaturated nitrile monomers. Suitable (C₁-C₁₂)alkyl-(meth)acrylate and aryl-(meth)acrylate monomers, alkenyl aromatic monomers and monoethylenically unsaturated nitrile monomers include those set forth hereinabove in the description of the rubber substrate. In addition, the rigid thermoplastic resin phase may, provided that the Tg limitation for the phase is satisfied, optionally include up to about 10 wt. % of third repeating units derived from one or more other copolymerizable monomers.

The rigid thermoplastic phase typically comprises one or more alkenyl aromatic polymers. Suitable alkenyl aromatic polymers comprise at least about 20 wt. % structural units derived from one or more alkenyl aromatic monomers. In one embodiment the rigid thermoplastic phase comprises an alkenyl aromatic polymer having structural units derived from one or more alkenyl aromatic monomers and from one or more monoethylenically unsaturated nitrile monomers. Examples of such alkenyl aromatic polymers include, but are not limited to, styrene/acrylonitrile copolymers, alpha-methylstyrene/acrylonitrile copolymers, or alpha-methylstyrene/styrene/acrylonitrile copolymers. In another particular embodiment the rigid thermoplastic phase comprises an alkenyl aromatic polymer having structural units derived from one or more alkenyl aromatic monomers; from one or more monoethylenically unsaturated nitrile monomers; and from one or more monomers selected from the group consisting of (C₁-C₁₂)alkyl- and aryl-(meth)acrylate monomers. Examples of such alkenyl aromatic polymers include, but are not limited to, styrene/acrylonitrile/methyl methacrylate copolymers, alpha-methylstyrene/acrylonitrile/methyl methacrylate copolymers and alpha-methylstyrene/styrene/acrylonitrile/methyl methacrylate copolymers. Further examples of suitable alkenyl aromatic polymers comprise styrene/methyl methacrylate copolymers, styrene/maleic anhydride copolymers; styrene/acrylonitrile/maleic anhydride copolymers, and styrene/acrylonitrile/acrylic acid copolymers. These copolymers may be used for the rigid thermoplastic phase either individually or as mixtures.

When structural units in copolymers are derived from one or more monoethylenically unsaturated nitrile monomers, then the amount of nitrile monomer added to form the copolymer comprising the grafted copolymer and the rigid thermoplastic phase may be in one embodiment in a range of between about 5 wt. % and about 40 wt. %, in another embodiment in a range of between about 5 wt. % and about 30 wt. %, in another embodiment in a range of between about 10 wt. % and about 30 wt. %, and in yet another embodiment in a range of between about 15 wt. % and about 30 wt. %, based on the total weight of monomers added to form the copolymer comprising the grafted copolymer and the rigid thermoplastic phase.

When structural units in copolymers are derived from one or more (C₁-C₁₂)alkyl- and aryl-(meth)acrylate monomers, then the amount of the said monomer added to form the copolymer comprising the grafted copolymer and the rigid thermoplastic phase may be in one embodiment in a range of between about 5 wt. % and about 50 wt. %, in another embodiment in a range of between about 5 wt. % and about 45 wt. %, in another embodiment in a range of between about 10 wt. % and about 35 wt. %, and in yet another embodiment in a range of between about 15 wt. % and about 35 wt. %, based on the total weight of monomers added to form the copolymer comprising the grafted copolymer and the rigid thermoplastic phase.

The amount of grafting that takes place between the rubber substrate and monomers comprising the rigid thermoplastic phase varies with the relative amount and composition of the rubber phase. In one embodiment, greater than about 10 wt. % of the rigid thermoplastic phase is chemically grafted to the rubber substrate, based on the total amount of rigid thermoplastic phase in the composition. In another embodiment, greater than about 15 wt. % of the rigid thermoplastic phase is chemically grafted to the rubber substrate, based on the total amount of rigid thermoplastic phase in the composition. In still another embodiment, greater than about 20 wt. % of the rigid thermoplastic phase is chemically grafted to the rubber substrate, based on the total amount of rigid thermoplastic phase in the composition. In particular embodiments the amount of rigid thermoplastic phase chemically grafted to the rubber substrate may be in a range of between about 5 wt. % and about 90 wt. %; between about 10 wt. % and about 90 wt. %; between about 15 wt. % and about 85 wt. %; between about 15 wt. % and about 50 wt. %; or between about 20 wt. % and about 50 wt. %, based on the total amount of rigid thermoplastic phase in the composition. In yet other embodiments, about 40 wt. % to 90 wt. % of the rigid thermoplastic phase is free, that is, non-grafted.

The rigid thermoplastic phase may be present in the rubber modified thermoplastic resin in one embodiment at a level of from about 85 wt. % to about 6 wt. %; in another embodiment at a level of from about 65 wt. % to about 6 wt. %; in another embodiment at a level of from about 60 wt. % to about 20 wt. %; in another embodiment at a level of from about 75 wt. % to about 40 wt. %, and in still another embodiment at a level of from about 60 wt. % to about 50 wt. %, based on the weight of the rubber modified thermoplastic resin. In other embodiments the rigid thermoplastic phase may be present in a range of between about 90 wt. % and about 30 wt. %, based on the weight of the rubber modified thermoplastic resin.

The rigid thermoplastic phase may be formed solely by polymerization carried out in the presence of rubber substrate, or by addition of one or more separately synthesized rigid thermoplastic polymers to the rubber modified thermoplastic resin comprising the composition, or by a combination of both processes. In some embodiments the separately synthesized rigid thermoplastic polymer comprises structural units essentially identical to those of the rigid thermoplastic phase comprising the rubber modified thermoplastic resin. In some particular embodiments separately synthesized rigid thermoplastic polymer comprises structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate. When at least a portion of separately synthesized rigid thermoplastic polymer is added to the rubber modified thermoplastic resin, then the amount of said separately synthesized rigid thermoplastic polymer added is in one embodiment in a range of between about 5 wt. % and about 90 wt. %, in another embodiment in a range of between about 5 wt. % and about 80 wt. %, in another embodiment in a range of between about 10 wt. % and about 70 wt. %, in another embodiment in a range of between about 15 wt. % and about 65 wt. %, and in still another embodiment in a range of between about 20 wt. % and about 65 wt. %, based on the weight of resinous components in the composition. Two or more different rubber substrates, each possessing a different mean particle size, may be separately employed in a polymerization reaction to prepare rigid thermoplastic phase, and then the products blended together to make the rubber modified thermoplastic resin. In illustrative embodiments wherein such products each possessing a different mean particle size of initial rubber substrate are blended together, then the ratios of said substrates may be in a range of about 90:10 to about 10:90, or in a range of about 80:20 to about 20:80, or in a range of about 70:30 to about 30:70. In some embodiments an initial rubber substrate with smaller particle size is the major component in such a blend containing more than one particle size of initial rubber substrate.

The rigid thermoplastic phase may be made according to known processes, for example, mass polymerization, emulsion polymerization, suspension polymerization or combinations thereof, wherein at least a portion of the rigid thermoplastic phase is chemically bonded, i.e., “grafted” to the rubber phase via reaction with unsaturated sites present in the rubber phase. The grafting reaction may be performed in a batch, continuous or semi-continuous process. Representative procedures include, but are not limited to, those taught in U.S. Pat. No. 3,944,631; and in U.S. patent application Ser. No. 08/962,458, filed Oct. 31, 1997. The unsaturated sites in the rubber phase are provided, for example, by residual unsaturated sites in those structural units of the rubber that were derived from a graftlinking monomer. In some embodiments of the present invention monomer grafting to rubber substrate with concomitant formation of rigid thermoplastic phase may optionally be performed in stages wherein at least one first monomer is grafted to rubber substrate followed by at least one second monomer different from said first monomer. Representative procedures for staged monomer grafting to rubber substrate include, but are not limited to, those taught in commonly assigned U.S. patent application Ser. No. 10/748,394, filed Dec. 30, 2003.

In a preferred embodiment the rubber modified thermoplastic resin is an ASA graft copolymer such as that manufactured and sold by General Electric Company under the trademark GELOY®, and preferably an acrylate-modified acrylonitrile-styrene-acrylate graft copolymer. ASA polymeric materials include, for example, those disclosed in U.S. Pat. No. 3,711,575. Acrylonitrile-styrene-acrylate graft copolymers comprise those described in commonly assigned U.S. Pat. Nos. 4,731,414 and 4,831,079. In some embodiments of the invention where an acrylate-modified ASA is used, the ASA component further comprises an additional acrylate-graft formed from monomers selected from the group consisting of C₁ to C₁₂ alkyl- and aryl-(meth)acrylate as part of either the rigid phase, the rubber phase, or both. Such copolymers are referred to as acrylate-modified acrylonitrile-styrene-acrylate graft copolymers, or acrylate-modified ASA. A preferred monomer is methyl methacrylate to result in a PMMA-modified ASA (sometimes referred to hereinafter as “MMA-ASA”).

Compositions of the invention also comprise one or more additives which alone or together may serve to reduce or eliminate plate-out during thermal processing of the composition. In some embodiments compositions of the invention also comprise one or more additives which alone or together may serve to increase the value of critical shear rate of the composition as determined by capillary rheometry at either 190° C. or 210° C., in comparison to said value in the absence of said one or more additives. In general the amount of said one or more additives present in compositions of the invention is an amount effective to increase the critical strain rate value as determined by capillary rheometry at either 190° C. or 210° C., in comparison to said value in the absence of said one or more additives. In other particular embodiments compositions of the invention comprise at least two additives selected from the group consisting of glass beads; fluoropolymers; ethylene bis-stearamide; a mixture of at least one metal salt of a fatty acid and at least one amide; a homopolymer comprising structural units derived from at least one (C₁-C₁₂)alkyl(meth)acrylate monomer; and mixtures thereof. Glass beads suitable for use in the compositions of the invention may be solid or hollow, and may optionally be surface-treated. When present, illustrative examples of suitable surface treatment agents for glass beads comprise silane coupling agents. In one particular embodiment the size of the glass beads is in a range of between about - microns and about 50 microns, in another particular embodiment in a range of between about 1 micron and about 20 microns, and in still another particular embodiment in a range of between about 1 micron and about 10 microns. Said glass beads may be present in compositions of the invention in an amount in a range of between 0 parts per hundred parts resin (phr) and about 20 phr, or in an amount in a range of between 0.1 phr and about 4 phr, or in an amount in a range of between 0.1 phr and about 3 phr, or in an amount in a range of between 0.5 phr and about 2.5 phr. Although glass beads are generally preferred because of their availability and cost, it should be understood that other hard, essentially spherical materials such as, but not limited to, ceramic beads, may also be used.

Suitable fluoropolymers and methods for making such fluoropolymers are known, as described for example, in U.S. Pat. Nos. 3,671,487 and 3,723,373. Suitable fluoropolymers comprise homopolymers and copolymers that comprise structural units derived from one or more fluorinated olefin monomers. The term “fluorinated-olefin monomer” means an olefin monomer that includes at least one fluorine atom substituent. Suitable fluorinated olefin monomers comprise fluoroethylenes including, but are not limited to, CF₂═CF₂, CHF═CF₂, CH₂═CF₂, CH₂═CHF, CClF═CF₂, CCl₂═CF₂, CClF═CClF, CHF═CCl₂, CH₂═CClF, and CCl₂═CClF and fluoropropylenes including, but are not limited to, CF₃CF═CF₂, CF₃CF═CHF, CF₃CH═CF₂, CF₃CH═CH₂, CHF₂CF═CHF, CHF₂CH═CHF and CHF₂CH═CH₂. In a preferred embodiment, the fluorinated olefin monomer comprises one or more of tetrafluoroethylene, chlorotrifloroethylene, vinylidene fluoride or hexafluoropropylene. Suitable fluorinated olefin homopolymers include for example, poly(tetra-fluoroethylene) and poly(hexafluoroethylene).

Suitable fluorinated olefin copolymers include copolymers comprising structural units derived from two or more fluorinated olefin copolymers such as, for example, poly(tetrafluoroethylene-hexafluoroethylene), and copolymers comprising structural units derived from one or more fluorinated monomers and one or more non-fluorinated monoethylenically unsaturated monomers that are copolymerizable with the fluorinated monomers including, but are not limited to, poly(tetrafluoroethylene-ethylene-propylene) copolymers. Suitable non-fluorinated monoethylenically unsaturated monomers comprise olefin monomers including, but are not limited to, ethylene, propylene butene, acrylate monomers such as, for example, methyl methacrylate, butyl acrylate, vinyl ethers, such as, for example, cyclohexyl vinyl ether, ethyl vinyl ether, n-butyl vinyl ether, and vinyl esters such as, for example, vinyl acetate, and vinyl versatate. In particular embodiments suitable fluoropolymers comprise polytetrafluoroethylene (PTFE), perfluoropolyethers, and fluoroelastomers. In particular embodiments suitable fluoropolymers comprise polytetrafluoroethylene (PTFE), perfluoropolyethers, and fluoroelastomers. In other particular embodiments suitable fluoropolymers are in particulate form or in fibrous form. In another particular embodiment suitable fluoropolymers are in particulate form with particles ranging in size from about 50 nm to about 500 nm, as measured by electron microscopy.

When polytetrafluoroethylene is employed, it is typically present in the rubber modified thermoplastic resin in an amount in a range of between about 0.1 phr and about 4 phr in one embodiment and in an amount in a range of between about 0.2 phr and about 3 phr in another embodiment. When perfluoropolyethers or fluoroelastomers are employed, they are typically present in the rubber modified thermoplastic resin at a level of from about 100 to about 5000 parts per million (ppm) in one embodiment; from about 100 to about 2000 ppm in another embodiment; and from about 200 to about 1000 ppm in still another embodiment

Since direct incorporation of a fluoropolymer into a thermoplastic resin composition is sometimes difficult, in some embodiments a fluoropolymer, for example in the form of a latex, may be pre-blended in some manner with a second polymer, including, but not limited to, a resinous component of the compositions of the present invention, such as, for example, an alkenyl aromatic polymer; a styrene-acrylonitrile resin; or a polyolefin. For example, an aqueous dispersion of PTFE fluoropolymer and an aqueous styrene-acrylonitrile resin emulsion may be precipitated to form a fluoropolymer concentrate and then dried to provide a PTFE-thermoplastic resin powder as disclosed in, for example, U.S. Pat. No. 4,579,906. Other suitable methods of forming a fluoropolymer masterbatch are disclosed in, for example, U.S. Pat. Nos. 5,539,036; 5,679,741; and 5,681,875. In a particular embodiment, the fluoropolymer masterbatch comprises PTFE in an amount in a range of between about 30 wt. % and about 70 wt. %, and more preferably in a range of between about 40 wt. % and about 60 wt. % PTFE, with the remainder comprising the second polymer. In another particular embodiment, the fluoropolymer masterbatch comprises a fluoroelastomer in an amount in a range of between about 1 wt. % and about 6 wt. %, and more preferably in a range of between about 1 wt. % and about 5 wt. % fluoroelastomer, with the remainder comprising the second polymer.

In another embodiment a fluoropolymer additive is made by emulsion polymerization of one or more monoethylenically unsaturated monomers in the presence of an aqueous fluoropolymer dispersion to form a second polymer in the presence of the fluoropolymer. Suitable monoethylenically unsaturated monomers are disclosed above. The emulsion is then precipitated, for example, by addition of sulfuric acid. The precipitate is dewatered, for example, by centrifugation, and then dried to form a fluoropolymer additive that comprises fluoropolymer and an associated second polymer. The dry emulsion polymerized fluoropolymer additive is in the form of a free-flowing powder.

In some particular embodiments suitable fluoropolymers comprise DYNAMAR FX5911 and DYNAMAR FX9613, available from 3M Company; FLUOROGUARD PRO and FLUOROGUARD PCA, available from DuPont Company; ZONYL MP1300 and ZONYL MP1000, available from DuPont Company; and POLYMIST F-5A and TECNOFLON N/M available from Solvay Solexis.

Compositions of the invention may also comprise mixtures of at least one metal salt of a fatty acid and at least one amide. The fatty acids generally comprise from 16 to 18 carbon atoms. Representative examples include stearic acid, oleic acid, palmitic acid and mixtures thereof. In a preferred embodiment the fatty acid comprises stearic acid. Fatty acid mixtures may additionally comprise 9,12-linoleic acid, 9,11-linoleic acid (conjugated linoleic acid), pinolenic acid, palmitoleic acid, magaric acid, octadecadienoic acid, octadecatrienoic acid, and the like. Fatty acid mixtures may contain minor amounts of rosin acids. Illustrative rosin acids include, but are not limited to, those generally found in tall oil fatty acid mixtures, and may comprise abietic acid, dihydroabietic acid, palustric/levopimaric acid, pimaric acids, tetrahydroabietic acid, isopimaric acid, neoabietic acid, and the like. Suitable metal salts include, but are not limited to, those comprising aluminum, magnesium, calcium, and zinc, and mixtures thereof. In some embodiments suitable amides comprise those derived from C₈-C₁₈ carboxylic acids and hydroxy-substituted amines. The ratio of fatty acid metal salt to amide component in the mixture is that which is effective to obtain a reduction in plate-out in compositions of the invention. Mixtures of at least one metal salt of a fatty acid and at least one amide may be prepared by mixing the individual components. Commercial mixtures suitable for use in compositions of the present invention comprise those available from Struktol Company of America (Stow, Ohio), including, but are not limited to, STRUKTOL TR 251, STRUKTOL TR 255, STRUKTOL TR 071, and STRUKTOL TR 016. In various embodiments the amount of said mixture in compositions of the invention may be in a range of between 0 phr and about 5 phr, or in a range of between about 0.2 phr and about 4 phr, or in a range of between about 0.5 phr and about 4 phr, or in a range of between about 1 phr and about 3 phr.

Homopolymers comprising structural units derived from at least one (C₁-C₁₂)alkyl(meth)acrylate monomer are sometimes referred to herein as “acrylic polymers”. Suitable (C₁-C₁₂)alkyl(meth)acrylate monomers for use in the said homopolymers comprise those (C₁-C₁₂)alkyl(meth)acrylate monomers described hereinabove. In particular embodiments suitable (C₁-C₁₂)alkyl(meth)acrylate monomers include, but are not limited to, (C₁-C₁₂)alkyl acrylate monomers, illustrative examples of which comprise ethyl acrylate, butyl acrylate, iso-pentyl acrylate, n-hexyl acrylate, and 2-ethyl hexyl acrylate; and their (C₁-C₁₂)alkyl methacrylate analogs, illustrative examples of which comprise methyl methacrylate, ethyl methacrylate, propyl methacrylate, iso-propyl methacrylate, butyl methacrylate, hexyl methacrylate, and decyl methacrylate. In a particular embodiment the homopolymer comprises structural units derived from methyl methacrylate (said polymer being known as poly(methyl methacrylate) or PMMA). When present, the amount of homopolymer in compositions of the invention may be in one embodiment in a range of between about 5 wt. % and about 40 wt. %, in another embodiment in a range of between about 10 wt. % and about 40 wt. %, and in another embodiment in a range of between about 15 wt. % and about 35 wt. %, based on the weight of resinous components in the composition.

Compositions of the invention may optionally comprise at least one additive selected from the group consisting of a silicone oil and a linear low density polyethylene. Silicone oils suitable for use in compositions of the invention comprise those with a viscosity in a range of between about 0.1 and about 10 pascal-seconds in one embodiment; in a range of between about 0.1 and about 2 pascal-seconds in another embodiment; and in a range of between about 0.5 and about 1.5 pascal-seconds in still another embodiment. Silicone oils are available from, for example, General Electric, Wacker Silicones and Dow Corning. In a particular embodiment a suitable silicone oil comprises polydimethylsiloxane. Said silicone oil may be present in compositions of the invention in an amount in a range of between 0 phr and about 1 phr, or in an amount in a range of between 0.05 phr and about 0.5 phr, or in an amount in a range of between 0.05 phr and about 0.25 phr.

Suitable linear low density polyethylene additives are available from numerous commercial sources and have melt index and density which may be determined by those skilled in the art without undue experimentation. In particular embodiments suitable linear low density polyethylene additives have properties effective to provide beneficial properties to the compositions of the invention, such as, but not limited to, improved flow properties or reduced plate-out, or both. Said linear low density polyethylene may be present in compositions of the invention in an amount in a range of between 0 phr and about 8 phr; or in an amount in a range of between 0.1 phr and about 4 phr; or in an amount in a range of between 0.1 phr and about 3 phr; or in an amount in a range of between 0.5 phr and about 2.5 phr.

Compositions of the present invention may also optionally comprise additives known in the art including, but not limited to, stabilizers, such as color stabilizers, heat stabilizers, light stabilizers, antioxidants, UV screeners, and UV absorbers; flame retardants, anti-drip agents, lubricants, flow promoters and other processing aids; plasticizers, antistatic agents, mold release agents, impact modifiers, fillers, and colorants such as dyes and pigments which may be organic, inorganic or organometallic; and like additives. Illustrative additives include, but are not limited to, silica, silicates, zeolites, titanium dioxide, stone powder, glass fibers or spheres, carbon fibers, carbon black, graphite, calcium carbonate, talc, lithopone, zinc oxide, zirconium silicate, iron oxides, diatomaceous earth, calcium carbonate, magnesium oxide, chromic oxide, zirconium oxide, aluminum oxide, crushed quartz, clay, calcined clay, talc, kaolin, asbestos, cellulose, wood flour, cork, cotton and synthetic textile fibers, especially reinforcing fillers such as glass fibers, carbon fibers, metal fibers, and metal flakes, including, but not limited to aluminum flakes. Often more than one additive is included in compositions of the invention, and in some embodiments more than one additive of one type is included. In a particular embodiment a composition further comprises an additive selected from the group consisting of colorants, dyes, pigments, lubricants, stabilizers, heat stabilizers, light stabilizers, antioxidants, UV screeners, UV absorbers, fillers and mixtures thereof.

Compositions of the invention and articles made therefrom may be prepared by known thermoplastic processing techniques. Known thermoplastic processing techniques which may be used include, but are not limited to, extrusion, calendering, kneading, profile extrusion, sheet extrusion, coextrusion, molding, extrusion blow molding, thermoforming, injection molding, co-injection molding and rotomolding. The invention further contemplates additional fabrication operations on said articles, such as, but not limited to, in-mold decoration, baking in a paint oven, surface etching, lamination, and/or thermoforming. In particular embodiments compositions of the invention may be processed in any application in which friction may occur between melt and a metal surface, and abrasion resistance of the melt is desired. In a particular embodiment compositions of the invention may be processed in applications in which plate-out may occur. In a preferred embodiment compositions of the invention are employed in a profile extrusion process. In other particular embodiments compositions of the invention can be extruded to make sheet, pipe or profile with excellent appearance using general extrusion lines equipped with calibrators at normal production speed.

Compositions of the present invention have improved values for critical shear rate which are believed to result in more stable flow and improved resistance of the compositions to plate-out during thermal processing. Improved values for critical shear rate may be obtained in some embodiments by adjusting the ratio between the rubber modified thermoplastic resin and one or more of the required additives. Optimized ratios may be readily determined by those skilled in the art without undue experimentation. In a particular embodiment compositions of the invention exhibit a critical shear rate in one embodiment greater than about 50 reciprocal seconds; in another embodiment greater than about 60 reciprocal seconds; in another embodiment greater than about 70 reciprocal seconds; in another embodiment greater than about 80 reciprocal seconds; in another embodiment greater than about 90 reciprocal seconds; and in still another embodiment greater than about 100 reciprocal seconds as measured at 190° C. in a capillary rheometer with 10 millimeter (mm) length and 1 mm diameter. In another particular embodiment compositions of the invention exhibit a critical shear rate in one embodiment greater than about 150 reciprocal seconds; in another embodiment greater than about 200 reciprocal seconds; in another embodiment greater than about 300 reciprocal seconds; in another embodiment greater than about 400 reciprocal seconds; in another embodiment greater than about 500 reciprocal seconds; in another embodiment greater than about 600 reciprocal seconds; and in still another embodiment greater than about 700 reciprocal seconds as measured at 210° C. in a capillary rheometer with 10 mm length and 1 mm diameter. In another particular embodiment compositions of the invention show improved resistance to plate-out during extrusion in the presence of a vacuum calibrator. In still another particular embodiment compositions of the invention show improved resistance to plate-out during profile extrusion.

Compositions of the present invention are suitable for use in applications that may require high notched Izod impact strength (NII) values. Parts molded from compositions of the invention exhibit NII values in one particular embodiment of greater than about 5 kilojoules per square meter (kJ/m²); in another particular embodiment of greater than about 6 kJ/m²; in another particular embodiment of greater than about 7 kJ/m²; and in still another particular embodiment of greater than about 8 kJ/m²; as determined according to ISO 180 at room temperature. In another particular embodiment profile-extruded parts exhibit notched Izod impact strength values in the ranges given herein above. Compositions of the invention may also comprise regrind or reworked resinous components.

The compositions of the present invention can be formed into useful articles. In some embodiments the articles comprise unitary articles. Illustrative unitary articles comprise a profile consisting essentially of a composition of the present invention. In still other embodiments the articles may comprise multilayer articles comprising at least one layer comprising a composition of the present invention. In various embodiments multilayer articles may comprise a cap-layer comprising a composition of the invention and a substrate layer comprising at least one thermoplastic resin different from said cap-layer. In some particular embodiments said substrate layer comprises at least one of an acrylic polymer; PMMA; a rubber-modified acrylic polymer; rubber-modified PMMA; ASA; poly(vinyl chloride) (PVC); acrylonitrile-butadiene-styrene copolymer (ABS); polycarbonate (PC); and mixtures comprising at least one of the aforementioned materials, including, but not limited to, mixtures of ASA and PC; mixtures of ABS and PC; mixtures of ABS and an acrylic polymer; and mixtures of ABS and PMMA. In some particular embodiments PC consists essentially of bisphenol A polycarbonate. In addition in some embodiments said multilayer article may comprise at least one substrate layer and at least one tielayer between said substrate layer and said cap-layer. Additional illustrative examples of resins suitable for substrate layers comprise polyesters, such as poly(alkylene terephthalates), poly(alkylene naphthalates), poly(ethylene terephthalate), poly(butylene terephthalate), poly(trimethylene terephthalate), poly(ethylene naphthalate), poly(butylene naphthalate), poly(cyclohexanedimethanol terephthalate), poly(cyclohexanedimethanol-co-ethylene terephthalate), poly( 1,4-cyclohexane-dimethyl-1,4-cyclohexanedicarboxylate), polyarylates, the polyarylate with structural units derived from resorcinol and a mixture of iso- and terephthalic acids, polyestercarbonates, the polyestercarbonate with structural units derived from bisphenol A, carbonic acid and a mixture of iso- and terephthalic acids, the polyestercarbonate with structural units derived from resorcinol, carbonic acid and a mixture of iso- and terephthalic acids, and the polyestercarbonate with structural units derived from bisphenol A, resorcinol, carbonic acid and a mixture of iso- and terephthalic acids. Additional illustrative examples of resins suitable for substrate layers further comprise aromatic polyethers such as polyarylene ether homopolymers and copolymers such as those comprising 2,6-dimethyl-1,4-phenylene ether units, optionally in combination with 2,3,6-trimethyl-1,4-phenylene ether units; polyetherimides, polyetherketones, polyetheretherketones, polyethersulfones; polyarylene sulfides and sulfones, such as polyphenylene sulfides, polyphenylene sulfones, and copolymers of polyphenylene sulfides with polyphenylene sulfones; polyamides, such as poly(hexamethylene adipamide) and poly(ε-aminocaproamide); polyolefin homopolymers and copolymers, such as polyethylene, polypropylene, and copolymers containing at least one of ethylene and propylene; polyacrylates, poly(methyl methacrylate), poly(ethylene-co-acryl ate)s including SURLYN; polystyrene, syndiotactic polystyrene, poly(styrene-co-acrylonitrile), poly(styrene-co-maleic anhydride); and compatibilized blends comprising at least one of any of the aforementioned resins, such as thermoplastic polyolefin (TPO); poly(phenylene ether)-polystyrene, poly(phenylene ether)-polyamide, poly(phenylene ether)-polyester, poly(butylene terephthalate)-polycarbonate, poly(ethylene terephthalate)-polycarbonate, polycarbonate-polyetherimide, and polyester-polyetherimide. Suitable substrate layers may comprise recycled or reground thermoplastic resin.

Multilayer articles comprising a cap-layer comprised of a composition of the present invention may exhibit improved weatherability compared to similar articles without said cap-layer. Applications for articles comprising compositions of the present invention include, but are not limited to, sheet, pipe capstock, hollow tubes, solid round stock, square cross-section stock, and the like. More complex shapes can also be made, such as those used for building and construction applications, especially a window frame, a sash door frame, pricing channels, corner guards, house siding, gutters, handrails, down-spouts, fence posts, and the like.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

In the following examples resinous components are expressed in wt. %. Non-resinous components are expressed in phr. The abbreviation “C. Ex.” means Comparative Example. Gloss was measured according to ASTM D523 taking 10 measurements across the width of a test part at 5 locations along the length of said test part. Values for gloss level are presented as the mean value of 50 results. Gloss uniformity was determined by taking 10 measurements of gloss across the width of a test part at 5 locations along the length of gloss lines along the test part, followed by calculation of the standard deviation. Gloss uniformity is reported as the mean of 5 standard deviation values. A lower value for gloss uniformity means that the test part surface is more uniform as is desired. Notched Izod impact strength (NII) values in units of kilojoules per square meter were determined according to ISO 180. Tensile modulus and tensile strength values, both in units of megapascals, were determined according to ISO 527. Flexural strength and flexural modulus values, both in units of megapascals, were determined according to ISO 178. HDT values in ° C. were determined according to ISO 179. Plate-out on molded test parts was determined by visually observing the surface of the test parts. When no plate-out was visible, the surfaces of test parts were wiped with a cloth and the cloth examined for plate-out deposit. The designation “none” in the table indicates that no plate-out deposit was observed on the cloth used for wiping the parts. The designation “none visible” means that no plate-out deposit was observed on the surface of molded test parts but, when the test parts were wiped with a cloth, traces of plate-out deposit were seen on the cloth.

### EXAMPLES 1-2 AND COMPARATIVE EXAMPLES 1-2

Compositions were compounded and then co-extruded as cap layer over PVC profile extruded test parts. The test parts were evaluated for plate-out and gloss performance, and results are shown in the table. Compositional components are shown in Table 1. ASA was a copolymer comprising structural units derived from 37.5 wt. % styrene, 18 wt. % acrylonitrile, and about 44.5 wt. % butyl acrylate. The types of SAN employed were SAN-1, a copolymer comprising 75 wt. % styrene and 25 wt. % acrylonitrile; SAN-2, a copolymer comprising 72 wt. % styrene and 28 wt. % acrylonitrile with a weight average molecular weight (Mw) of about 100,000 made by a bulk polymerization process; and SAN-3, a copolymer comprising 72 wt. % styrene and 28 wt. % acrylonitrile with Mw in a range of between about 160,000 and about 180,000 made by a bulk polymerization process. All of the compositions comprised 1 phr ethylene bis-stearamide (EBS) wax and 1.4 phr of a mixture of hindered phenolic anti-oxidants, ultraviolet light absorbers, and phosphorus-comprising stabilizers. Molded test parts were also prepared of the pure compositions. Rheological and mechanical properties of these test parts are also shown in the table. Values for critical shear rate in units of reciprocal seconds were determined at 190° C. or at 210° C. using a capillary rheometer with 1 mm diameter and 10 mm length.

TABLE 1

| Component | Example 1 | Example 2 | C. Ex. 1 | C. Ex. 2 |
|---|---|---|---|---|
| ASA | 33.33 | 66.67 | 60 | 35 |
| SAN-1 | 35.56 | 17.8 | — | — |
| SAN-2 | — | — | 40 | — |
| SAN-3 | — | — | — | 65 |
| PMMA | 31.11 | 15.53 | — | — |
| Glass Beads | 2 | 2 | — | — |
| PTFE powder | 0.5 | — | — | — |
| LLDPE | 2 | 2 | — | — |
| Silicone oil | 0.15 | 0.15 | — | — |
| Observed | none | some | severe | severe |
| plate-out | | | | |
| Gloss level | 68 | 24 | 20 | 30 |
| Gloss | 1.5 | 4 | 2 | 3.5 |
| uniformity | | | | |
| Critical shear | 300 | 90 | 50 | 50 |
| rate, 190° C. | | | | |
| Critical shear | 935 | 430 | 200 | 250 |
| rate, 210° C. | | | | |
| NII | 4.5 | 13 | 9 | 8 |
| Flexural | 2347 | 1552 | 1790 | 2800 |
| modulus | | | | |
| Flexural | 67 | 47 | 59 | 79 |
| strength | | | | |
| Tensile | 2282 | 1533 | 1790 | 3030 |
| modulus | | | | |
| Tensile | 41 | 30 | 41 | 57 |
| strength | | | | |

Comparative Examples 1 and 2 represent samples of extrusion-grade ASA. The critical shear rate values for Comparative Examples 1 and 2 are very low, and test parts comprising said compositions show severe plate-out. Examples 1 and 2, representing compositions of the invention, show higher critical shear rate values and greatly reduced plate-out formation in test parts compared to the Comparative Examples. The gloss for Example 1 showed similar trend with plate-out phenomena. When the critical shear rate value increased, the gloss level increased and gloss uniformity value decreased, thus showing marked improvement over similar values for Comparative Examples 1 and 2.

### EXAMPLES 3-6 AND COMPARATIVE EXAMPLE 3

Compositions were compounded and then co-extruded as cap layer over PVC profile extruded test parts. The test parts were evaluated for plate-out and gloss performance, and results are shown in the table. Compositional components are shown in Table 2. All of the compositions comprised 1 phr EBS wax and 1.4 phr of a mixture of hindered phenolic anti-oxidants, ultraviolet light absorbers, and phosphorus-comprising stabilizers (referred to hereinafter as “additives”). MMA-ASA was a copolymer comprising structural units derived from about 11 wt. % methyl methacrylate, about 30 wt. % styrene, about 14 wt. % acrylonitrile, and about 45 wt. % butyl acrylate. MMA-SAN was a copolymer comprising structural units derived from 35 wt. % methyl methacrylate, 40 wt. % styrene, and 25 wt. % acrylonitrile made by a bulk polymerization process. The mixture of fatty acid metal salt and amide was STRUKTOL TR 251, a proprietary composition obtained from Struktol Company of America. Molded test parts were also prepared of the pure compositions. Rheological, thermal, and mechanical properties of these test parts are also shown in the table. Values for critical shear rate in units of reciprocal seconds were determined at 190° C. using a capillary rheometer with 1 mm diameter and 10 mm length.

TABLE 2

| Component | Ex. 3 | Ex. 4 | Ex. 5 | Ex. 6 | C. Ex. 3* |
|---|---|---|---|---|---|
| MMA-ASA | 55 | 55 | 50 | 55 | 60 |
| MMA-SAN | 45 | 35 | 50 | 35 | 40 |
| PMMA | — | 10 | — | 10 | |
| fatty acid metal | 3 | 3 | 2 | 2 | — |
| salt/amide | | | | | |
| PTFE powder | — | — | 2 | 2 | — |
| Observed | none | slight | slight | some | severe |
| plate-out | | | | | |
| Critical shear rate | 120 | 100 | 140 | 80 | 50 |
| NII | 13 | 11.5 | 11.4 | 11.9 | 15 |
| HDT | 71 | 71 | 72 | 68 | 72 |
| Flexural modulus | 1443 | 1405 | 1641 | 1452 | 1328 |
| Tensile modulus | 1822 | 1751 | 1945 | 1694 | 1670 |
| Tensile strength | 37 | 37 | 41 | 36 | 36 |

*also contains 0.25 phr oxidized polyethylene

Comparative Example 3 represents a sample of extrusion-grade ASA. The critical shear rate value for Comparative Example 3 is very low, and test parts comprising said composition show severe plate-out. Examples 3-6, representing compositions of the invention, show higher critical shear rate values and greatly reduced plate-out formation in test parts compared to the Comparative Example. Examples 3-6 also showed good mechanical properties making them eminently suitable in profile extrusion applications.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A composition comprising: (i) a rubber modified thermoplastic resin comprising a discontinuous elastomeric phase dispersed in a rigid thermoplastic phase, wherein at least a portion of the rigid thermoplastic phase is grafted to the elastomeric phase; (ii) at least two additives selected from the group consisting of glass beads; fluoropolymers; ethylene bis-stearamide; a mixture of at least one metal salt of a fatty acid and at least one amide; a homopolymer comprising structural units derived from at least one (C₁-C₁₂)alkyl(meth)acrylate monomer; and mixtures thereof; and optionally (iii) at least one additive selected from the group consisting of a silicone oil and a linear low density polyethylene,
wherein said composition has a critical shear rate value of greater than about 50 reciprocal seconds as measured at 190° C. in a capillary rheometer with 10 mm length and 1 mm diameter.

2. The composition of claim 1, wherein the elastomeric phase comprises a polymer having structural units derived from at least one (C₁-C₁₂)alkyl(meth)acrylate monomer.

3. The composition of claim 2, wherein the elastomeric phase comprises a polymer having structural units derived from butyl acrylate.

4. The composition of claim 3, wherein the polymer of the elastomeric phase further comprises structural units derived from at least one polyethylenically unsaturated monomer.

5. The composition of claim 4, wherein the polyethylenically unsaturated monomer is selected from the group consisting of butylene diacrylate, divinyl benzene, butene diol dimethacrylate, trimethylolpropane tri(meth)acrylate, allyl methacrylate, diallyl methacrylate, diallyl maleate, diallyl fumarate, diallyl phthalate, triallyl methacrylate, triallyl isocyanurate, triallyl cyanurate, the acrylate of tricyclodecenylalcohol and mixtures thereof.

6. The composition of claim 1, wherein the elastomeric phase comprises about 10 wt. % to about 80 wt. % of the rubber modified thermoplastic resin.

7. The composition of claim 1, wherein the elastomeric phase comprises about 35 wt. % to about 80 wt. % of the rubber modified thermoplastic resin.

8. The composition of claim 1, wherein at least about 5 wt. % to about 90 wt. % of rigid thermoplastic phase is chemically grafted to the elastomeric phase, based on the total amount of rigid thermoplastic phase in the composition.

9. The composition of claim 1, wherein the rigid thermoplastic phase comprises structural units derived from at least one monomer selected from the group consisting of vinyl aromatic monomers, monoethylenically unsaturated nitrile monomers, (C₁-C₁₂)alkyl- and aryl-(meth)acrylate monomers, and mixtures thereof.

10. The composition of claim 1, wherein the rigid thermoplastic phase comprises structural units derived from styrene and acrylonitrile; or styrene, alpha-methyl styrene, and acrylonitrile; or styrene, acrylonitrile, and methyl methacrylate; or alpha-methyl styrene, acrylonitrile and methyl methacrylate; or styrene, alpha-methyl styrene, acrylonitrile and methyl methacrylate.

11. The composition of claim 1, wherein at least a portion of rigid thermoplastic phase is prepared in a separate polymerization step and added to the rubber modified thermoplastic resin.

12. The composition of claim 11, wherein the portion of rigid thermoplastic phase prepared in a separate polymerization step comprises structural units derived from styrene and acrylonitrile.

13. The composition of claim 11, wherein the portion of rigid thermoplastic phase prepared in a separate polymerization step comprises structural units derived from styrene, acrylonitrile and methyl methacrylate.

14. The composition of claim 11, wherein the portion of rigid thermoplastic phase prepared in a separate polymerization step is present in an amount of between about 5 wt. % and about 90 wt. %, based on the weight of resinous components in the composition.

15. The composition of claim 1, wherein the additives comprise a plurality of glass beads; at least one fluoropolymer; ethylene bis-stearamide; at least one homopolymer comprising structural units derived from at least one (C₁-C₁₂)alkyl(meth)acrylate monomer; at least one silicone oil; and a linear low density polyethylene.

16. The composition of claim 15, wherein the fluoropolymer comprises polytetrafluoroethylene.

17. The composition of claim 15, wherein the homopolymer comprises poly(methyl methacrylate).

18. The composition of claim 1, wherein the additives comprise at least one fluoropolymer; ethylene bis-stearamide; a mixture of at least one metal salt of a fatty acid and at least one amide; and a homopolymer comprising structural units derived from at least one (C₁-C₁₂)alkyl(meth)acrylate monomer.

19. The composition of claim 18, wherein the fluoropolymer is selected from the group consisting of polytetrafluoroethylene, perfluoropolyethers, and fluoroelastomers.

20. The composition of claim 18, wherein the homopolymer comprises poly(methyl methacrylate).

21. The composition of claim 1, further comprising at least one additive selected from the group consisting of a stabilizer; a color stabilizer; a heat stabilizer; a light stabilizer; an antioxidant; a UV screener; a UV absorber; a flame retardant; an anti-drip agent; a lubricant; a flow promoter; a processing aid; a plasticizer; an antistatic agent; a mold release agent; an impact modifier; a filler; a colorant; a dye; a pigment; and mixtures thereof.

22. The composition of claim 1, which exhibits a notched Izod impact strength value of greater than about 6 kJ/m² as determined according to ISO 180 at room temperature for molded test parts.

23. The composition of claim 1, which exhibits a notched Izod impact strength value of greater than about 8 kJ/m² as determined according to ISO 180 at room temperature for molded test parts.

24. A composition comprising: (i) a rubber modified thermoplastic resin comprising a discontinuous elastomeric phase comprising structural units derived from butyl acrylate dispersed in a rigid thermoplastic phase comprising structural units derived from styrene and acrylonitrile or from styrene, acrylonitrile, and methyl methacrylate, wherein at least a portion of the rigid thermoplastic phase is grafted to the elastomeric phase; and (ii) additives comprising a plurality of glass beads; at least one fluoropolymer; ethylene bis-stearamide; at least one homopolymer comprising structural units derived from at least one (C₁-C₁₂)alkyl(meth)acrylate monomer; a silicone oil; and a linear low density polyethylene;
wherein said composition has a critical shear rate value of greater than about 50 reciprocal seconds as measured at 190° C. in a capillary rheometer with 10 mm length and 1 mm diameter.

25. The composition of claim 24, wherein the fluoropolymer is selected from the group consisting of polytetrafluoroethylene, perfluoropolyethers, and fluoroelastomers.

26. The composition of claim 24, wherein the homopolymer comprises poly(methyl methacrylate).

27. The composition of claim 24, further comprising at least one additive selected from the group consisting of a stabilizer; a color stabilizer; a heat stabilizer; a light stabilizer; an antioxidant; a UV screener; a UV absorber; a flame retardant; an anti-drip agent; a lubricant; a flow promoter; a processing aid; a plasticizer; an antistatic agent; a mold release agent; an impact modifier; a filler; a colorant; a dye; a pigment; and mixtures thereof.

28. The composition of claim 24, having a critical shear rate value of greater than about 300 reciprocal seconds as measured at 210° C. in a capillary rheometer with 10 mm length and 1 mm diameter.

29. The composition of claim 24, which exhibits a notched Izod impact strength value of greater than about 6 kJ/m² as determined according to ISO 180 at room temperature for molded test parts.

30. A method for reducing or eliminating plate-out during extrusion of a composition comprising a rubber modified thermoplastic resin comprising a discontinuous elastomeric phase comprising structural units derived from butyl acrylate dispersed in a rigid thermoplastic phase comprising structural units derived from styrene and acrylonitrile or from styrene, acrylonitrile, and methyl methacrylate, wherein at least a portion of the rigid thermoplastic phase is grafted to the elastomeric phase;
which comprises adding to the composition at least two additives selected from the group consisting of a plurality of glass beads; at least one fluoropolymer; ethylene bis-stearamide; at least one homopolymer comprising structural units derived from at least one (C₁-C₁₂)alkyl(meth)acrylate monomer; a silicone oil; and a linear low density polyethylene.

31. The method of claim 30, wherein the composition has a critical shear rate value of greater than about 50 reciprocal seconds as measured at 190° C. in a capillary rheometer with 10 mm length and 1 mm diameter.

32. The method of claim 30, wherein the composition has a critical shear rate value of greater than about 300 reciprocal seconds as measured at 210° C. in a capillary rheometer with 10 mm length and 1 mm diameter.

33. A composition comprising: (i) a rubber modified thermoplastic resin comprising a discontinuous elastomeric phase comprising structural units derived from butyl acrylate dispersed in a rigid thermoplastic phase comprising structural units derived from styrene and acrylonitrile or from styrene, acrylonitrile, and methyl methacrylate, wherein at least a portion of the rigid thermoplastic phase is grafted to the elastomeric phase; and (ii) additives comprising ethylene bis-stearamide; at least one fluoropolymer; at least one homopolymer comprising structural units derived from at least one (C₁-C₁₂)alkyl(meth)acrylate monomer; and a mixture of at least one metal salt of a fatty acid and at least one amide;
wherein said composition has a critical shear rate value of greater than about 50 reciprocal seconds as measured at 190° C. in a capillary rheometer with 10 mm length and 1 mm diameter.

34. The composition of claim 33, wherein the fluoropolymer is selected from the group consisting of polytetrafluoroethylene, perfluoropolyethers, and fluoroelastomers.

35. The composition of claim 33, wherein the homopolymer comprises poly(methyl methacrylate).

36. The composition of claim 33, further comprising at least one additive selected from the group consisting of a stabilizer; a color stabilizer; a heat stabilizer; a light stabilizer; an antioxidant; a UV screener; a UV absorber; a flame retardant; an anti-drip agent; a lubricant; a flow promoter; a processing aid; a plasticizer; an antistatic agent; a mold release agent; an impact modifier; a filler; a colorant; a dye; a pigment; and mixtures thereof.

37. The composition of claim 33, which exhibits a notched Izod impact strength value of greater than about 6 kJ/m² as determined according to ISO 180 at room temperature for molded test parts.

38. A method for reducing or eliminating plate-out during extrusion of a composition comprising a rubber modified thermoplastic resin comprising a discontinuous elastomeric phase comprising structural units derived from butyl acrylate dispersed in a rigid thermoplastic phase comprising structural units derived from styrene and acrylonitrile or from styrene, acrylonitrile, and methyl methacrylate, wherein at least a portion of the rigid thermoplastic phase is grafted to the elastomeric phase;
which comprises adding to the composition at least two additives selected from the group consisting of ethylene bis-stearamide; at least one fluoropolymer; at least one homopolymer comprising structural units derived from at least one (C₁-C₁₂)alkyl(meth)acrylate monomer; and a mixture of at least one metal salt of a fatty acid and at least one amide.

39. The method of claim 38 wherein the composition has a critical shear rate value of greater than about 50 reciprocal seconds as measured at 190° C. in a capillary rheometer with 10 mm length and 1 mm diameter.

40. An article made from the composition of claim 1.

41. An article made from the composition of claim 24.

42. An article made from the composition of claim 33.
